(19) United States
(12) Patent Application Publication
(10) Pub. No.: US 2023/0025942 A1
(43) Pub. Date: Jan. 26, 2023

(54) USE OF A HEAT TRANSFER COMPOSITION FOR CONTROLLING THE TEMPERATURE OF A BATTERY

(71) Applicant: ARKEMA FRANCE, Colombes (FR)

(72) Inventors: Jeremie WALKER, PIERRE-BENITE CEDEX (FR); Dominique GARRAIT, PIERRE-BENITE CEDEX (FR); Bernard MONGUILLON, COLOMBES CEDEX (FR); Laurent ABBAS, PIERRE-BENITE CEDEX (FR)

(21) Appl. No.: 17/791,060

(22) PCT Filed: Jan. 19, 2021
(86) PCT No.: PCT/FR2021/050095

§ 371 Date: Jul. 6, 2022

(30) Foreign Application Priority Data
Jan. 20, 2020 (FR) FR2000543

(51) Int. Cl. H01M 10/6567; H01M 10/625; H01M 10/613

(52) U.S. Cl. CPC H01M 10/6567; H01M 10/625; H01M 10/613; H01M 2220/20

(57) ABSTRACT

The present invention relates to the use of a, preferably single-phase, heat transfer composition, comprising at least one aromatic synthetic dielectric fluid chosen from alkylbenzenes, alkyldiphenylethanes, alkylnaphthalenes, methylpolyarylmethanes, and mixtures thereof, for regulating the temperature of a battery.

The present invention also relates to a battery comprising such a heat transfer composition.

The present invention relates to the use of a heat transfer composition comprising at least one oil for cooling a battery of an electric or hybrid vehicle.

The batteries of electric or hybrid vehicles give a maximum efficiency under specific conditions of use and especially in a very specific temperature range. Thus, in cold climates, the autonomy of electric or hybrid vehicles is a problem, all the more so since the high heating requirements consume a large proportion of the stored electrical energy. In addition, at low temperatures, the power available from the battery is low, which poses a driving problem. Moreover, the cost of the battery contributes significantly toward the cost of the electric or hybrid vehicle.

Conversely, cooling of the battery is a major safety issue. It is now known that various dielectric oils may be used to cool the battery of an electric or hybrid vehicle. However, when rapid battery charging is required, the use of conventional dielectric oils is generally not sufficient to effectively cool the battery, in particular due to their high viscosity and their excessively low thermal conductivity in some cases.

Furthermore, it is important to use compositions that are sparingly flammable or non-flammable, or at the very least that have relatively high flash points, in the vicinity of the battery so as to eliminate any safety risks associated with the use of these compositions.

Document U.S. Pat. No. 8,852,772 describes an example of a lithium-ion battery cooling system for use in a vehicle, said system comprising a plurality of cooling modules capable of receiving a dielectric liquid in channels which heat and cool the battery.

Document WO 2019/197783 relates to a process for cooling and/or heating a body or a fluid in a motor vehicle, by means of a system comprising a vapor compression circuit in which a first heat transfer composition flows and a secondary circuit in which a second heat transfer composition flows.

There remains today a need for dielectric fluids, in particular single-phase dielectric fluids, which make it possible to ensure optimal operation of batteries, in particular batteries of electric or hybrid vehicles, so as to provide so as to provide safe and efficient batteries without increasing the costs associated with said batteries. The term “single-phase” is understood to mean a phase that is completely liquid and which remains liquid during use, i.e. during temperature regulation, as opposed to phase change systems in which temperature regulation is carried out by vaporization/condensation of a refrigerant liquid.

Thus, and according to a first aspect, the present invention relates to the use of a, preferably single-phase, heat transfer composition, comprising at least one aromatic synthetic dielectric fluid chosen from alkylbenzenes, alkyldiphenylethanes, alkylnaphthalenes, methylpolyarylmethanes, and mixtures thereof, for regulating the temperature of a battery.

The present invention makes it possible to meet the needs expressed above. Specifically, it makes it possible to ensure optimum operation of batteries, notably in electric or hybrid vehicles, so as to provide safe and efficient batteries without increasing the costs associated with the batteries.

Specifically, the use of an aromatic synthetic dielectric fluid chosen from alkylbenzenes, alkyldiphenylethanes, alkylnaphthalenes, methylpolyarylmethanes, and mixtures thereof makes it possible to provide a less viscous composition and a greater thermal conductivity, in particular in comparison with the compositions of the prior art, which makes it possible to increase the efficiency of the batteries, in particular during fast charging, without increasing the costs thereof.

In addition, the composition for use according to the invention has very good thermal characteristics and also a breakdown voltage entirely compatible with said use, and in particular a breakdown voltage which is generally greater than or equal to 20 kV. These qualities linked to the aromatic synthetic dielectric fluid chosen from alkylbenzenes, alkyldiphenylethanes, alkylnaphthalenes, methylpolyarylmethanes, and mixtures thereof ensure that the dielectric properties of the composition are compatible with use near or in contact with the battery.

The use according to the present invention is very particularly suitable for batteries and notably the batteries of electric or hybrid vehicles, and more generally batteries fitted to electric or hybrid means of transport, such as motor vehicles, trucks, trains, boats, two-wheeled vehicles, (bicycles, motorcycles, scooters), industrial vehicles (such as tractors, diggers, forklifts, agricultural machinery, and others), but also for automatons (such as ATMs, currency dispensers, ticket dispensers, and others), and also the battery charging stations themselves.

Systems with electric or hybrid motors, and in particular motor vehicles, comprise at least one electric motor, and where appropriate a combustion engine. They thus comprise an electronic circuit and a traction battery, denoted more simply as a battery in the text below.

The battery may comprise at least one electrochemical cell and preferably a plurality of electrochemical cells. Each electrochemical cell may comprise a negative electrode, a positive electrode and an electrolyte interposed between the negative electrode and the positive electrode. Each electrochemical cell can also comprise a separator, in which the electrolyte is impregnated.

The electrochemical cells can be assembled in series and/or in parallel in the battery.

The term “negative electrode” is understood to mean the electrode which acts as anode when the battery delivers current (that is to say, when it is in the process of discharging) and which acts as cathode when the battery is in the process of charging. The negative electrode typically comprises an electrochemically active material, optionally an electronically conductive material, and optionally a binder.

The term “positive electrode” is understood to mean the electrode which acts as cathode when the battery delivers current (that is to say, when it is in the process of discharging) and which acts as anode when the battery is in the process of charging. The positive electrode typically comprises an electrochemically active material, optionally an electronically conductive material, and optionally a binder.

The term “electrochemically active material” is understood to mean a material capable of reversibly inserting ions.

The term “electronically conductive material” is understood to mean a material capable of conducting electrons.

The negative electrode of the electrochemical cell can in particular comprise, as electrochemically active material, graphite, lithium, a lithium alloy, a lithium titanate of Li₄Ti₅O₁₂ type or titanium oxide TiO₂, silicon or a lithium/silicon alloy, a tin oxide, a lithium intermetallic compound or a mixture thereof.

When the negative electrode comprises lithium, the latter can be in the form of a film of metal lithium or of an alloy comprising lithium. Mention may be made, for example, among the lithium-based alloys capable of being used, of lithium-aluminum alloys, lithium-silica alloys, lithium-tin alloys, Li—Zn, Li₃Bi, Li₃Cd and Li₃SB. An example of negative electrode can comprise an active lithium film prepared by rolling a strip of lithium between rollers.

The positive electrode comprises an electrochemically active material of oxide type. It is a lithium/nickel/manganese/cobalt composite oxide having a high nickel content (LiNiₓMn_{y}Co_{z}O₂ with x+y+z=1, abbreviated to NMC, with x>y and x>z), or a lithium/nickel/cobalt/aluminum composite oxide having a high nickel content (LiNi_{x′}Co_{y′}Al_{z′} with x′+y′+z′=1, abbreviated to NCA, with x′>y′ and x′>z′).

Specific examples of these oxides are NMC532 (LiNi_{0.5}Mn_{0.3}Co_{0.2}O₂), NMC622 (LiNi_{0.6}Mn_{0.2}Co_{0.2}O₂) and NMC811 (LiNi_{0.5}Mn_{0.1}Co_{0.1}O₂).

Mixtures of these oxides can be used. The oxide material described above can, if appropriate, be combined with another oxide, such as, for example: manganese dioxide (MnO₂), iron oxide, copper oxide, nickel oxide, lithium/manganese composite oxides (for example LiₓMn₂O₄ or LiₓMnO₂), lithium/nickel composition oxides (for example LiₓNiO₂), lithium/cobalt composition oxides (for example LiₓCoO₂), lithium/nickel/cobalt composite oxides (for example LiNi_{1-y}Co_{y}O₂), lithium and transition metal composite oxides, lithium/manganese/nickel composite oxides of spinel structure (for example LiₓMn_{2-y}Ni_{y}O₄), vanadium oxides, NMC and NCA oxides which do not have a high nickel content and mixtures thereof.

Preferably, the NMC or NCA oxide having a high nickel content represents at least 50% by weight, preferably at least 75% by weight, more preferably at least 90% by weight and more preferably essentially all of the oxide material present in the positive electrode as electrochemically active material.

The material of each electrode can also comprise, besides the electrochemically active material, an electronically conductive material, such as a carbon source, including, for example, carbon black, Ketjen® carbon, Shawinigan carbon, graphite, graphene, carbon nanotubes, carbon fibers (for example, vapor-grown carbon fibers or VGCF), non-powdery carbon obtained by carbonization of an organic precursor, or a combination of two or more of these. Other additives can also be present in the material of the positive electrode, such as lithium salts or inorganic particles of ceramic or glass type, or also other compatible active materials (for example sulfur).

The material of each electrode can also comprise a binder. Nonlimiting examples of binders comprise linear, branched and/or crosslinked polyether polymer binders (for example polymers based on poly(ethylene oxide) (PEO), or poly(propylene oxide) (PPO) or on a mixture of the two (or an EO/PO copolymer), and optionally comprising crosslinkable units), water-soluble binders (such as SBR (styrene/butadiene rubber), NBR (acrylonitrile/butadiene rubber), HNBR (hydrogenated NBR), CHR (epichlorohydrin rubber), ACM (acrylate rubber)), or binders of fluoropolymer type (such as PVDF (polyvinylidene fluoride), PTFE (polytetrafluoroethylene)), and combinations thereof. Some binders, such as those which are soluble in water, can also comprise an additive, such as CMC (carboxymethylcellulose).

The separator can be a porous polymer film. By way of nonlimiting example, the separator can consist of a porous film of polyolefin, such as ethylene homopolymers, propylene homopolymers, ethylene/butene copolymers, ethylene/hexene copolymers, ethylene/methacrylate copolymers or multilayer structures of the above polymers.

The electrolyte can consist of one or more lithium salts dissolved in a solvent or a mixture of solvents with one or more additives.

Byway of nonlimiting examples, the lithium salt or the lithium salts can be chosen from LiPF₆ (lithium hexafluorophosphate), LiFSI (lithium bis(fluorosulfonyl)imide), LiTDI (lithium 2-trifluoromethyl-4,5-dicyanoimidazolate), LiPOF₂, LiB(C₂O₄)₂, LiF₂B(C₂O₄)₂, LiBF₄, LiNO₃ or LiClO₄.

The solvent(s) can be chosen from the following nonexhaustive list: ethers, esters, ketones, sulfur derivatives, alcohols, nitriles and carbonates.

Mention may be made, among the ethers, of linear or cyclic ethers, such as, for example, dimethoxyethane (DME), methyl ethers of oligoethylene glycols having 2 to 5 oxyethylene units, dioxolane, dioxane, dibutyl ether, tetrahydrofuran and mixtures thereof.

Mention may be made, among the esters, of phosphoric acid esters or sulfite esters. Mention may be made, for example, of methyl formate, methyl acetate, methyl propionate, ethyl acetate, butyl acetate, γ-butyrolactone and mixtures thereof.

Among the sulfur derivatives, nonlimiting examples that may be mentioned include sulfoxides, such as dimethyl sulfoxide (DMSO) or sulfones such as sulfolane or dimethyldisulfone (DMSO₂).

Mention may in particular be made, among the ketones, of cyclohexanone. Mention may be made, among the alcohols, for example, of ethyl alcohol or isopropyl alcohol.

Mention may be made, among the nitriles, for example, of acetonitrile, pyruvonitrile, propionitrile, methoxypropionitrile, dimethylaminopropionitrile, butyronitrile, isobutyronitrile, valeronitrile, pivalonitrile, isovaleronitrile, glutaronitrile, methoxyglutaronitrile, 2-methylglutaronitrile, 3-methylglutaronitrile, adiponitrile, malononitrile and mixtures thereof.

Mention may be made, among the carbonates, for example, of cyclic carbonates, such as, for example, ethylene carbonate (EC) (CAS: 96-49-1), propylene carbonate (PC) (CAS: 108-32-7), butylene carbonate (BC) (CAS: 4437-85-8), dimethyl carbonate (DMC) (CAS: 616-38-6), diethyl carbonate (DEC) (CAS: 105-58-8), ethyl methyl carbonate (EMC) (CAS: 623-53-0), diphenyl carbonate (CAS: 102-09-0), methyl phenyl carbonate (CAS: 13509-27-8), dipropyl carbonate (DPC) (CAS: 623-96-1), methyl propyl carbonate (MPC) (CAS: 1333-41-1), ethyl propyl carbonate (EPC), vinylidene carbonate (VC) (CAS: 872-36-6), fluoroethylene carbonate (FEC) (CAS: 114435-02-8), trifluoropropylene carbonate (CAS: 167951-80-6) or mixtures thereof.

The additive(s) can be chosen from the group consisting of fluoroethylene carbonate (FEC), vinylene carbonate, 4-vinyl-1,3-dioxolan-2-one, pyridazine, vinylpyridazine, quinoline, vinylquinoline, butadiene, sebaconitrile, alkyl disulfides, fluorotoluene, 1,4-dimethoxytetrafluorotoluene, t-butylphenol, di(t-butyl)phenol, tris(pentafluorophenyl)borane, oximes, aliphatic epoxides, halogenated biphenyls, methacrylic acids, allyl ethyl carbonate, vinyl acetate, divinyl adipate, propane sultone, acrylonitrile, 2-vinylpyridine, maleic anhydride, methyl cinnamate, phosphonates, silane compounds containing a vinyl, and 2-cyanofuran.

The heat transfer composition that can be used in the context of the present invention comprises an aromatic synthetic dielectric fluid chosen from alkylbenzenes, alkyldiphenylethanes, alkylnaphthalenes, methylpolyarylmethanes, and mixtures thereof. For the purposes of the present invention, the term “dielectric fluid” means a fluid which does not conduct electricity (or is only sparingly conductive) but allows electrostatic forces to be exerted.

Among the aromatic synthetic dielectric fluids, mention may be made, in a nonlimiting manner, of alkylbenzenes, alkyldiphenylethanes (for example phenylxylylethane (PXE), phenylethylphenylethane (PEPE), monoisopropylbiphenyl (MIPB), 1,1-diphenylethane (1,1-DPE)), alkylnaphthalenes (for example diisopropylnaphthalene (DIPN)), methylpolyarylmethanes (for example benzyltoluene (BT) and dibenzyltolulene DBT), and mixtures thereof. In said aromatic synthetic dielectric fluids, it should be understood that at least one ring is aromatic and that optionally one or more other rings present may be partially or totally unsaturated. Most particularly preferred examples are the dielectric fluids sold by Soltex Inc, by the company Arkema under the name Jarylec®, and SAS 60E by the company JX Nippon Chemical Texas Inc.

According to yet another preferred embodiment of the present invention, the dielectric fluid is chosen from benzyltoluene (BT), dibenzyltoluene (DBT) and mixtures thereof in any proportions. The preferred BT/DBT mixtures are those comprising between 60% and 85%, limits included, by weight of benzyltoluene and between 15% and 40%, limits included, by weight of dibenzyltoluene, relative to the total amount of benzyltoluene/dibenzyltoluene.

In a very particularly preferred embodiment, the dielectric fluid is chosen from the dielectric fluids sold by Arkema under the brand names of the Jarylec® range.

Other dielectric fluids suitable for the requirements of the present invention are, for example, those sold by Yantai Jinzheng, in particular under the brand name SRS-401T, those sold by Jinzhou Yongia, in particular M/DBT, and those sold by JX Nippon, in particular under the brand name SAS-60E.

Mention may be made, as yet other examples of dielectric fluids suitable for the requirements of the present invention, of:

diphenylethane (DPE) and isomers thereof, in particular 1,1-DPE (CAS: 612-00-0), 1,2-DPE (CAS: 103-29-7) and mixtures thereof (in particular CAS: 38888-98-1), such fluids are commercially available or are described in the literature, for example in document EP 0 098 677,

ditolyl ether (DT) and isomers thereof, in particular those corresponding to the numbers CAS: 4731-34-4, CAS: 28299-41-4 and mixtures thereof, these being in particular commercially available from Lanxess, under the trade name DiphylDT,

phenylxylylethane (PXE) and isomers thereof, in particular those corresponding to the numbers CAS: 6196-95-8, CAS: 76090-67-0 and mixtures thereof, in particular commercially available from Changzhou Winschem, under the brand name PXE oil,

1,2,3,4-tetrahydro-(1-phenylethyl)naphthalene (CAS: 63674-30-6), this product being commercially available in particular from Dow under the reference Dowtherm™ RP,

diisopropylnaphthalene (CAS: 38640-62-9), in particular available from Indus Chemie Ltd under the brand name KMC 113,

monoisopropylbiphenyl and isomers thereof (CAS: 25640-78-2), in particular available under the brand name Wemcol, and

phenylethylphenylethane (PEPE) and isomers thereof (CAS: 6196-94-7), in particular available from Changzhou Winschem or Yantaï Jinzheng, to mention only the main dielectric fluids known and usable in the context of the present invention.

All the aromatic synthetic dielectric fluids above can be used, alone or as mixtures of two or more of them in any proportions. In one embodiment, the use according to the present invention employs a heat transfer composition comprising at least one aromatic synthetic dielectric fluid, alone or as a mixture with one or more other dielectric fluids known to a person skilled in the art, such as, for example and without limitation, dielectric fluids chosen from mineral oils, vegetable oils and natural or synthetic esters.

The amount of aromatic synthetic dielectric fluid(s) relative to the sum total of all the dielectric fluids that can be used for the purposes of the present invention can vary within large proportions. It is however preferred to use aromatic synthetic dielectric fluids in proportions of between 50% and 100% by weight, limits included, preferably between 70% and 100% by weight, limits included, relative to the sum total of all of the dielectric fluids present in the heat transfer composition that can be used for the purposes of the present invention.

According to another embodiment, the heat transfer composition that can be used in the context of the present invention comprises at least one aromatic synthetic dielectric fluid as a mixture with at least one other dielectric fluid chosen from dielectric fluids well known to a person skilled in the art. These dielectric fluids are mainly and most commonly chosen from mineral, synthetic and vegetable dielectric oils and mixtures thereof, in any proportions.

Among the mineral dielectric oils, mention may be made, in a nonlimiting manner, of paraffinic oils and naphthenic oils, such as the dielectric oils of the Nytro family, sold by Nynas (in particular Nytro Taurus, Nytro Libra, Nytro 4000X and Nytro 10XN), and Diala family, sold by Shell.

Among the synthetic dielectric oils, mention may be made, in a nonlimiting manner, of aliphatic hydrocarbons, silicone oils, and esters, and also mixtures of two or more of them in any proportions. Among the aliphatic hydrocarbons, mention may be made, in a nonlimiting manner, of poly-α-olefins (PAO), for example polyisobutenes (PIB) or olefins of vinylidene type, such as those sold, for example, by Soltex Inc.

Among the silicone oils, mention may be made, in a nonlimiting manner, of linear silicone oils of the polydimethylsiloxane type, for instance those sold by Wacker under the name Wacker® AK.

Among the synthetic esters, mention may be made, in a nonlimiting manner, of esters of the phthalic type such as dioctyl phthalate (DOP) or diisononyl phthalate (DINP) (sold, for example, by BASF).

Mention may also be made, in a nonlimiting manner, of esters resulting from the reaction between a polyalcohol and an organic acid, in particular an acid chosen from saturated or unsaturated C₄ to C₂₂ organic acids. As nonlimiting examples of such organic acids, mention may be made of undecanoic acid, heptanoic acid, octanoic acid, palmitic acid and mixtures thereof. Among the polyols which can be used for the synthesis of the abovementioned esters, nonlimiting examples that may be mentioned include pentaerytritol.

Thus, the synthetic esters resulting from the reaction between a polyalcohol and an organic acid are for example the products of the Midel® range, for instance Midel® 7131, or from the Mivolt® range, for instance Mivolt® DFK and Mivolt® DF7 from M&I Materials, or else the esters of the Nycodiel range from Nyco.

Among the natural esters and plant oils, nonlimiting examples that may be mentioned include products from oily seeds or from other sources of natural origin. Nonlimiting examples that may be mentioned include FR3™ or else Envirotemp™ sold by Cargill or else Midel EN 1215 sold by M&I Materials.

As indicated above, the heat transfer composition of the present invention may comprise one dielectric fluid or more, for example two, or three, or four or five dielectric fluids.

According to one embodiment, a preferred aromatic synthetic dielectric fluid is a methylpolyarylmethane and more particularly a mixture of benzyltoluene and dibenzyltoluene. More preferably, the aromatic synthetic dielectric fluid according to the invention comprises a single fluid or two fluids. In this case, it is preferable for this fluid to be a methylpolyarylmethane and more particularly a mixture of benzyltoluene and dibenzyltoluene.

The heat transfer composition that can be used in the context of the present invention may in particular have a viscosity of from 3 cSt to 50 cSt (or mm²/s) and more particularly a viscosity of between 5 cSt and 30 cSt. The viscosity is measured according to the ISO 3104 standard of 1994.

The heat transfer composition that can be used in the context of the present invention advantageously has a boiling point of between 120° C. and 550° C., preferably between 150° C. and 450° C., under atmospheric pressure. In a preferred embodiment of the present invention, the boiling point of the heat transfer composition is between 180° C. and 350° C. and even more preferably between 200° C. and 300° C. The boiling point is measured according to a method described in document no. 103 of the OECD adopted on Jul. 27, 1995.

The heat transfer composition that can be used in the context of the present invention may further comprise one or more additives and/or fillers well known to a person skilled in the art and chosen, for example, in a nonlimiting manner, from antioxidants, passivators, pour point depressants, decomposition inhibitors, fragrances and flavorings, colorants, preserving agents, and others, and mixtures thereof. A dielectric fluid which is very particularly preferred comprises a decomposition inhibitor.

Among the antioxidants that may advantageously be used in the heat transfer composition, nonlimiting examples that may be mentioned include phenolic antioxidants, for instance dibutylhydroxytoluene, butylhydroxyanisole, tocopherols, and also acetates of these phenolic antioxidants; but also antioxidants of amine type, for instance phenyl-α-naphthylamine, of diamine type, for example N,N′-bis(2-naphthyl)-para-phenylenediamine, but also ascorbic acid and salts thereof, ascorbic acid esters, alone or as mixtures of two or more thereof or with other components, for instance green tea extracts or coffee extracts. A very particularly suitable antioxidant is that commercially available from Brenntag under the trade name Ionol®.

The passivators which can be used as additives in the heat transfer composition which can be used in the context of the present invention are of any type known to a person skilled in the art and are advantageously chosen from triazole derivatives, benzimidazoles, imidazoles, thiazole or benzothiazole. Nonlimiting examples that may be mentioned include dioctylaminomethyl-2,3-benzotriazole and 2-dodecyldithioimidazole.

Among the pour point depressants that may be present in the heat transfer composition which can be used in the context of the present invention, nonlimiting examples that may be mentioned include fatty acid esters of sucrose, and acrylic polymers such as poly(alkyl methacrylate) or else poly(alkyl acrylate).

The preferred acrylic polymers are those for which the molecular weight is between 50 000 g·mol⁻¹ and 500 000 g·mol⁻¹. Examples of these acrylic polymers include polymers which can contain linear alkyl groups comprising from 1 to 20 carbon atoms.

Mention may be made, among these and still as nonlimiting examples, of poly(methyl acrylate), poly(methyl methacrylate), poly(heptyl acrylate), poly(heptyl methacrylate), poly(nonyl acrylate), poly(nonyl methacrylate), poly(undecyl acrylate), poly(undecyl methacrylate), poly(tridecyl acrylate), poly(tridecyl methacrylate), poly(pentadecyl acrylate), poly(pentadecyl methacrylate), poly(heptadecyl acrylate) and poly(heptadecyl methacrylate). An example of such a pour point depressant is commercially available from the company Sanyo Chemical Industries Ltd under the trade name Aclube.

According to a very particularly preferred aspect, the heat transfer composition which can be used in the context of the present invention comprises at least one decomposition inhibitor as additive. The decomposition inhibitor can be of any type well known to a person skilled in the art and in particular can be chosen from carbodiimide derivatives, such as diphenylcarbodiimide, ditolylcarbodiimide, bis(isopropylphenyl)carbodiimide or bis(butylphenyl)carbodiimide, but also from phenyl glycidyl ethers, or esters, alkyl glycidyl ethers, or esters, 3,4-epoxycyclohexylmethyl 3,4-epoxycyclohexanecarboxylate, compounds of the anthraquinone family, such as, for example, β-methylanthraquinone sold under the name “BMAQ”, epoxide derivatives, such as vinylcyclohexene diepoxides, 3,4-epoxy-6-methylcyclohexylmethyl 3,4-epoxy-6-methylhexanecarboxylate, phenol novolak type epoxy resins, bisphenol A diglycidyl ether epoxys, such as BADGE, or CEL 2021P, available in particular from Whyte Chemicals.

According to a specific embodiment of the invention, the heat transfer composition which can be used in the context of the present invention comprises at least one decomposition inhibitor.

The content by weight of the additive or additives optionally present in the composition which can be used in the context of the present invention can range from 0.0001% to 5% by weight, preferably from 0.001% to 3% by weight and more preferentially from 0.01% to 2% by weight, limits included, relative to the total weight of the composition.

The heat transfer composition which can be used in the context of the present invention has, according to a preferred embodiment, a volume resistivity of greater than or equal to 10⁷ Ω·cm, and preferably greater than or equal to 10⁸ Ω·cm. The resistivity of a material represents its capacity to oppose the flow of electric current. In other words, the volume resistivity is an indication of the dielectric properties of said dielectric fluid. The volume resistivity is measured according to the standard IEC 60247, 2004 edition.

For example, this volume resistivity may be from 10⁷ Ω·cm to 5×10⁷ Ω·cm; or from 5×10⁷ Ω·cm to 10⁸ Ω·cm; or from 10⁸ Ω·cm to 5×10⁸ Ω·cm; or from 5×10⁸ Ω·cm to 10⁹ Ω·cm; or from 10⁹ Ω·cm to 5×10⁹ Ω·cm; or from 5×10⁹ Ω·cm to 10¹⁰ Ω·cm.

Furthermore, the heat transfer composition according to the invention generally and usually has a breakdown voltage greater than or equal to 20 kV, preferably greater than or equal to 30 kV, preferably greater than or equal to 50 kV, and more preferably greater than or equal to 90 kV. The term “breakdown voltage” means the minimum electrical voltage that makes a portion of an insulator conductive. Thus, this parameter is also an indication of the dielectric properties of the heat transfer composition which can be used in the context of the present invention. The breakdown voltage is measured according to the standard IEC 60156, 2018 edition.

For example, the breakdown voltage of the heat transfer composition according to the invention may be within a range extending from 25 kV to 30 kV, or from 30 kV to 40 kV, or from 40 kV to 50 kV, or from 50 kV to 60 kV, or from 60 kV to 70 kV, or from 70 kV 25 to 80 kV, or from 80 kV to 90 kV.

The heat transfer composition is contained in a device, which is suitable for allowing heat exchange of the composition with the battery, and preferably also with a secondary source. The secondary source may be the surroundings, or an additional heat transfer composition.

In certain preferred embodiments, the device allows direct contact of the heat transfer composition with the vehicle's battery. Preferably, the vehicle's battery is immersed in the heat transfer composition. In this case, the device may comprise a closed chamber containing all or part of the battery, the heat transfer composition being contained within the chamber and in contact with the outer wall of the battery. This allows the dielectric and thermal properties of the heat transfer composition to be used to best advantage.

In certain embodiments, the heat transfer composition is entirely in the liquid state. In other embodiments, the heat transfer composition is partly in the liquid state and partly in the gaseous state. The pressure in the chamber is between 0 and 5 bar absolute. Preferably, the pressure is less than 3 bar absolute and preferably less than 1.5 bar absolute.

Cooling by direct contact of the battery with the heat transfer composition is particularly preferred in the case where the charging of the battery is a fast charge, which is involves rapid heating of the battery. The reason for this is that it enables faster heat exchange between the battery and the heat transfer composition, thus maintaining the cooling efficiency even when the cooling requirements increase.

Alternatively, the heat transfer composition may exchange heat with the battery via a heat exchanger. The device may then comprise a circuit in which the composition flows. The heat exchanger may notably be of the fluid/solid type, for example a plate exchanger.

Preferably, the circuit does not comprise a compressor. In other words, the circuit is not a vapor compression circuit.

Means for circulating the composition, for example a pump, may be provided.

When an additional heat transfer composition is provided, this may be present in an additional circuit, which may notably be a vapor compression circuit. The heat exchange between the compositions is performed in an additional heat exchanger, which may be, for example, co-current or, preferably, counter-current.

The additional heat transfer composition can itself exchange heat with the surroundings, by means of an additional heat exchanger. It can optionally also be used to heat or cool the air in the passenger compartment.

To this end, the additional circuit may include various branches with separate heat exchangers, the additional heat transfer composition optionally flowing in these branches, depending on the operating mode. Optionally, alternatively or additionally, the additional circuit may include means for changing the direction of flow of the additional heat transfer composition, for example comprising one or more three-way or four-way valves.

The term “countercurrent heat exchanger” means a heat exchanger in which heat is exchanged between a first fluid and a second fluid, the first fluid at the inlet of the exchanger exchanging heat with the second fluid at the outlet of the exchanger, and the first fluid at the outlet of the exchanger exchanging heat with the second fluid at the inlet of the exchanger.

For example, countercurrent heat exchangers comprise devices in which the flow of the first fluid and the flow of the second fluid are in opposite directions or virtually opposite directions. Exchangers operating in crosscurrent mode with a countercurrent tendency are also included among countercurrent heat exchangers. The heat exchangers can in particular be exchangers having U-shaped tubes, a horizontal or vertical tube bundle, spirals, plates or fins.

The invention relates to the use of a heat transfer composition according to the invention for regulating the temperature of the battery. Preferably, the composition is used for cooling the battery. It may also be used for heating the battery. Heating and cooling may be alternated depending on the need (outdoor temperature, battery temperature, operating mode of the battery). Heating may also be performed at least partly by means of electrical resistance.

It is thus possible to dedicate the heat transfer composition according to the invention solely to the cooling of the battery, whereas other means, for example electrical resistance, are used for heating it.

The term “temperature of the battery” generally means the temperature of an outer wall of one or more of its electrochemical cells.

The temperature of the battery can be measured by means of a temperature sensor. If several temperature sensors are present on the battery, the temperature of the battery can be regarded as being the mean of the various temperatures measured.

The temperature control can be performed when the vehicle's battery is being charged. Alternatively, it can be performed when the battery is discharging, notably when the vehicle's engine is switched on. It notably prevents the battery temperature from becoming excessive, on account of the outside temperature and/or on account of the intrinsic heating of said battery when it is functioning.

In particular, the charging of the battery can be fast charging. Thus, during the complete charging of the battery (from a moment when the battery is completely discharged) for a period of time of less than or equal to 30 min and preferably of less than or equal to 15 min, the use of the composition according to the invention makes it possible to maintain the temperature of the battery within an optimum temperature range. This is advantageous given that, during rapid charging, the battery tends to heat up rapidly and to reach high temperatures which may have an effect on its operation and its performance.

In certain embodiments, the cooling of the battery according to the invention makes it possible to lower the temperature of the battery by at least 5° C., or by at least 10° C., or by at least 15° C., or by at least 20° C., or by at least 25° C. or by at least 30° C.

In certain embodiments, the cooling of the battery is continuous over a certain period of time.

In certain embodiments, the cooling and optionally the heating allow the battery temperature to be maintained within an optimum temperature range, in particular when the vehicle is in operation (engine running), and notably when the vehicle is moving. Specifically, if the battery temperature is too low, its performance is liable to decrease significantly.

In certain embodiments, the temperature of the vehicle's battery may thus be maintained between a minimum temperature t1 and a maximum temperature t2.

In certain embodiments, the minimum temperature t1 is greater than or equal to 10° C. and the maximum temperature t2 is less than or equal to 40° C.; preferably, the minimum temperature t1 is greater than or equal to 15° C. and the maximum temperature t2 is less than or equal to 30° C., and more preferably the minimum temperature t1 is greater than or equal to 16° C. and the maximum temperature t2 is less than or equal to 28° C.

A feedback loop is advantageously present, in order to modify the operating parameters of the unit as a function of the temperature of the battery which is measured, in order to ensure that the desired temperature is maintained.

The outside temperature during the time that the vehicle's battery temperature is maintained between the minimum temperature t1 and the maximum temperature t2 may notably be from −60° C. to −50° C.; or from 50° C. to 40° C.; or from −40° C. to −30° C.; or from −30° C. to −20° C.; or from −20° C. to −10° C.; or from −10° C. to 0° C.; or from 0° C. to 10° C.; or from 10° C. to 20° C.; or from 20° C. to 30° C.; or from 30° C. to 40° C.; or from 40° C. to 50° C.; or from 50° C. to 60° C.; or else from 60° C. to 70° C.

The term “outside temperature” means the ambient temperature outside the vehicle before and during the maintenance of the temperature of the vehicle's battery between the minimum temperature t1 and the maximum temperature t2.

According to another aspect, the present invention relates to a battery comprising a heat transfer composition such as has just been defined above in the present description. The battery may be a battery fitted to electric or hybrid means of transport, such as motor vehicles, trucks, trains, boats, two-wheeled vehicles, (bicycles, motorcycles, scooters), industrial vehicles (such as tractors, diggers, forklifts, agricultural machinery, and others), but also fitted to automatons (such as ATMs, currency dispensers, ticket dispensers, and others), and also the battery charging stations themselves.

1-9. (canceled)

10. A single-phase heat transfer composition comprising at least one aromatic synthetic dielectric fluid selected from the group consisting of alkylbenzenes, alkyldiphenylethanes, alkylnaphthalenes, methylpolyarylmethanes, and mixtures thereof, for regulating the temperature of a battery.

11. The heat transfer composition of claim 10, wherein the at least one aromatic synthetic dielectric fluid is selected from the group consisting of benzyltoluene, dibenzyltoluene, and mixtures thereof in any proportions.

12. The heat transfer composition of claim 11, wherein the heat transfer composition comprises between 60% and 85%, limits included, by weight of benzyltoluene and between 15% and 40%, limits included, by weight of dibenzyltoluene relative to the total amount of benzyltoluene/dibenzyltoluene.

13. The heat transfer composition of claim 10, further comprising one or more other dielectric fluids selected from the group consisting of mineral oils, vegetable oils and synthetic oils, wherein the at least one aromatic synthetic dielectric fluid is mixed with the one or more other dielectric fluids.

14. The heat transfer composition of claim 13, wherein the aromatic synthetic dielectric fluids represent a proportion of between 50% and 100% by weight, limits included, relative to the total of all the dielectric fluids present in the heat transfer composition.

15. The heat transfer composition of claim 10, further comprising one or more additives and/or fillers.

16. The heat transfer composition of claim 15, wherein the content by weight of the additive or additives ranges from 0.0001% to 5% by weight, relative to the total weight of the composition.

17. A battery comprising the heat transfer composition of claim 10.

18. The battery as claimed in claim 17, fitted to an electric or hybrid means of transport, an industrial vehicle, an automaton or a charging station.

19. A method for regulating the temperature of a battery comprising using a single-phase heat transfer composition comprising at least one aromatic synthetic dielectric fluid selected from the group consisting of alkylbenzenes, alkyldiphenylethanes, alkylnaphthalenes, methylpolyarylmethanes, and mixtures thereof in the battery.

20. The heat transfer composition of claim 15, wherein the one or more additive and/or fillers comprise antioxidants, passivators, pour point depressants, decomposition inhibitors, fragrances and flavorings, colorants, preserving agents, or mixtures thereof.
